(19) United States
(12) Patent Application Publication
(10) Pub. No.: US 2010/0182637 A1
(43) Pub. Date: Jul. 22, 2010

(54) IMAGE FORMING APPARATUS, CONTROL METHOD, AND PROGRAM

(75) Inventor: Hirokazu Tamura, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/641,235

(22) Filed: Dec. 17, 2009

(30) Foreign Application Priority Data
Jan. 20, 2009 (JP) 2009-010406

(51) Int. Cl. G06F 3/12

(52) U.S. Cl. 358/1.15

(57) ABSTRACT

According to one aspect of the present invention, there is provided an image forming apparatus which performs print processing of image data, comprising: an expansion unit which performs downsampling processing for input image data, and then restores a target pixel of the image data, for which image processing has been performed, to the number of pixels at the time of input; a conversion unit which converts each pixel corresponding to the target pixel, restored to the number of pixels at the time of input by the expansion unit, into a pixel for printing; and a sort unit which reads each pixel corresponding to the target pixel converted by the conversion unit, reads the pixels in a raster order, and sorts the pixels.

### BACKGROUND OF THE INVENTION

1. Field of the Invention

The present invention relates to an image forming apparatus, image forming method, and program for upsampling an image to increase its resolution in a small memory.

2. Description of the Related Art

An electrophotographic scheme is known as an image printing scheme used for an image forming apparatuses such as printers and copying machines. The electrophotographic scheme is designed to form a latent image on a photosensitive drum by using a laser beam and develop the image with a charged colorant (to be referred to as toner hereinafter). The image is printed by transferring the image developed with the toner onto a transfer sheet and fixing the image on it.

With recent advances in technologies, images have increased in resolution, and the output resolution of the above electrophotographic apparatus has now reached a value as high as 1,200 dpi (dots per inch) or 2,400 dpi. In many cases, output sizes are standard sizes conforming to JIS standards and the like. For this reason, with an increase in resolution, the number of pixels of image data increases, and the size increases. In many cases, in order to process such a large-sized digital image (to be referred to as a high resolution image hereinafter) in real time, hardware specialized for the processing is generally used. Large-sized office equipment typified by a copying machine is required to print out an image input from a scanner in real time. That is, the print speed of the equipment is a criterion indicating its performance. This is a major reason for the necessity of real-time image processing using hardware. In the execution of image processing using hardware, the circuit size of the hardware and a built-in memory increase in proportion to the complexity degree of the processing and the size of an image to be processed. This processing therefore always has problems such as an increase in cost due to such increases, the prolongation of development periods, and the inflexible design for models.

Various techniques are known concerning image processing techniques for processing high resolution images like those described above at high speed and low cost. One of such techniques is image processing using downsampling. This technique has the effects of reducing the load of image processing by thinning out the data of an original digital image to decrease the number of pixels to be processed, and of reducing the memory capacity for accumulation owing to concurrent processing.

According to this technique, since original image data is always reduced, there is a tradeoff relationship between processing load and image quality (especially a degradation in resolution). That is, a careful consideration needs to be given to the manner of thinning out data. As one of techniques for this purpose, there is disclosed a method of minimizing degradation by preferentially thinning out information which is difficult to perceive and upsampling data which is easy to perceive (see Japanese Patent Laid-Open No. 2008-271046).

Downsampled data is equivalent to data having a reduced resolution, provided that the image size remains unchanged. For example, 1200-dpi image data becomes 600-dpi image data when thinned out to ½. It is, however, always necessary to transfer the data to a printer unit having high resolution print performance upon performing processing (upsampling) reverse to the above processing. The above reference also discloses an arrangement designed to perform both downsampling (subsampling) and upsampling.

In general, when performing image processing, the hardware performs processing in a given processing block pixel by pixel. Upon performing pixel-basis processing for one processing block, the process shifts to the next processing block to process the block. Repeating this operation will process one image. The number of pixels to be accumulated is generally minimized in a processing block. The purpose of this is to reduce the memory consumed, and this is because the size of the memory used for the processing influences the circuit size of hardware. Consider a processing sequence in a processing block of two-dimensional image data. In general, processing is sequentially performed from the upper left pixel in the rightward direction (to be referred to as the main scanning direction hereinafter) until one main scanning line (to be referred to as one line hereinafter) is processed, and then continuously performed from the left end of the next line (FIG. 3).

Processing blocks are often designed to sequentially transfer pixel data in this manner and transfer data to the next processing block in this order. Consider upsampling processing for data downsampled in 2×2 pixels. FIG. 4 shows a conceptual illustration of processing blocks in this case. That is, 2×2 pixels of original data are downsampled to one pixel, and image processing and accumulation are performed with a small number of pixels. Finally, upsampling processing is performed to restore the data to the number of pixels of the original data and print out the resultant data.

In the case of FIG. 4, the numbers in the pixels represent the processing sequence of the pixels when the line width of an image is set to 2n pixels. An input image is downsampled. Predetermined image processing is then performed for target data. When the image processing is complete, the resultant data is finally upsampled. In this upsampling processing, one pixel of input downsampled data corresponds to four pixels of output upsampled data.

Referring to, for example, FIG. 4, when the first pixel of downsampled data is input to an upsampling processing unit, the unit outputs four pixels, namely the 1st, 2nd, (2n+1)th, and (2n+2)th pixels. Since the subsequent print processing unit is assumed to receive data in the order of 1, 2, 3, and 4, which are continuous in the main scanning direction, the upsampling processing unit outputs the first and second pixels and accumulates the (2n+1)th and (2n+2)th pixels in the memory. The upsampling processing unit generates pixels 3, 4, 2n+3, and 2n+4 based on the second input. The unit then outputs pixels 3 and 4, and accumulates pixels 2n+3 and 2n+4 in the same manner. This makes it possible to output pixels in the subsequent processing while keeping the continuity of data like 1, 2, 3, and 4. The (2n+1)th and subsequent data in the memory can be output only after the last nth pixel of one line is input to the upsampling processing unit and the 2nth pixel is completely output. This processing requires a line memory for holding lines of the number obtained by subtracting one from the number of lines contained in a processing unit.

There is often used a technique of dividing an image into blocks to reduce the memory size for one line and lastly combining the blocks. Such problems concerning memory size in hardware are not limited to printers and also apply to displays designed to display image data while performing expansion. Some inventions have been made to solve such problems (see Japanese Patent Laid-Open No. 9-9066 and the like). According to such inventions, when performing displaying based on compressed image data typified by JPEG data, dither processing is performed in the minimum image processing units (in general, in 8×8 pixels in the case of MCU JPEG) to reduce the data bit depth, thereby reducing the memory consumed.

### SUMMARY OF THE INVENTION

However, a processing system designed to perform downsampling and upsampling as a pair of processes as described above needs to finally perform conversion to the resolution of a print processing unit. Even if processing before upsampling achieves memory saving, the memory capacity required inevitably increases after upsampling.

As described above, a processing block for outputting data having a pixel width in the sub scanning direction as typified by upsampling processing requires a line memory for guaranteeing the continuity of data. In addition, with an increase in main scanning width and an increase in the number of pixels per pixel, the memory size increases. In the above case of 2×2 sampling, one line memory is required. For example, when an A3-size image is input with an output resolution of 1,200 dpi, the number of pixels in the main scanning direction reaches as large as 14,000 pixels. When four colors C, M, Y, and K are expressed by 10 bits per pixel, the memory size per image reaches as large as 70 kbytes.

In order to solve these problems, there has been proposed a method of reducing a line memory by processing an image upon dividing it into predetermined blocks. For example, the above method disclosed in Japanese Patent Laid-Open No. 9-9066 compresses image data upon dividing it in a specific block size, and then performs image processing. Obviously, this makes it possible to reduce the line memory. Block processing, however, requires some technique for connecting the boundaries of divided blocks. That is, it is necessary to transfer some kind of data between blocks to avoid visual recognition of conspicuous discontinuity between the blocks (the boundaries of the blocks). For example, in processing using the dither method, it is necessary to secure, between adjacent blocks, the continuity of dither threshold matrices which are referred to between blocks. This will be described in detail with reference to the accompanying drawings.

The principle of image binarization (conversion to 1-bit data) by the dither method will be described first with reference to FIG. 5. An input multilevel image (e.g., an 8-bit gradation image) is divided into N×M (8×8 in FIG. 5) blocks. Thereafter, the gradation value of each pixel in a block is compared with a threshold in an N×M dither threshold matrix having the same size. If a given pixel value is larger than a threshold, black is output. If a given pixel level is equal to or less than the threshold, white is output. It is possible to binarize the entire image by performing this processing for all the pixels for each size.

Based on this, FIG. 6 shows a case in which an image is divided into blocks, each consisting of 8×8 pixels, and dither processing is performed on a block basis. Referring to FIG. 6, the dither matrix size is 20×12 pixels (indicated by the broken lines in FIG. 6). As in this case, the block size of an image does not always coincide with the dither matrix size. In the case of a color image, in particular, since the number of lines and the screen angle change between four color plates of C, M, Y, and K, the matrix size generally changes between the colors. It is known that this prevents moire between C, M, Y, and K. Assume that a dither matrix size differs from a processing block unit size as in this case. In this case, when blocks are finally joined to each other, the dither period becomes discontinuous at the joint boundaries, and the corresponding portions are visually recognized as streaks in the image unless the reference positions of a dither matrix are inherited between adjacent blocks.

An error diffusion method is available as a binarization method using no dither matrix. This is a technique of obtaining a binary image, with the density of an original image being retained, by diffusing the error, generated between the input and output densities when a target pixel is binarized, to neighboring pixels. In this case, it is necessary to diffuse error information between blocks. If errors are not diffused between blocks, streaks appear between the blocks as in the case of dither processing. Such diffusion of errors further requires a memory or area for an overlap between adjacent blocks. This requires redundant processing.

According to one aspect of the present invention, there is provided an image forming apparatus which performs print processing of image data, comprising: an expansion unit which performs downsampling processing for input image data, and then restores a target pixel of the image data, for which image processing has been performed, to the number of pixels at the time of input; a conversion unit which converts each pixel corresponding to the target pixel, restored to the number of pixels at the time of input by the expansion unit, into a pixel for printing; and a sort unit which reads each pixel corresponding to the target pixel converted by the conversion unit, reads the pixels in a raster order, and sorts the pixels.

Even in image processing in which the number of pixels to be processed increases as typified by upsampling, the present invention can minimize an increase in line memory required for the processing and output an image while maintaining the image quality of the final output image.

Further features of the present invention will become apparent from the following description of exemplary embodiments with reference to the attached drawings.

### BRIEF DESCRIPTION OF THE DRAWINGS

FIG. 1 is a block diagram showing an example of the schematic arrangement of an image forming apparatus according to an embodiment of the present invention;

FIG. 2 is a schematic view of the image forming apparatus according to the embodiment of the present invention;

FIG. 3 is a conceptual view showing an image scanning procedure;

FIG. 4 is a block diagram showing conventional processing procedures concerning downsampling and upsampling;

FIG. 5 is a view for explaining processing by the dither method;

FIG. 6 is a view for explaining the dither method using block processing;

FIG. 7 is a flowchart showing a processing procedure in the image forming apparatus according to the embodiment of the present invention;

FIG. 8 is a view showing the necessary position and capacity of a line memory in a normal processing sequence;

FIG. 9 is a view showing the necessary position and capacity of a line memory in a processing sequence according to the embodiment of the present invention;

FIG. 10 is a conceptual view showing an example of an image scanning sequence;

FIG. 11 is a view showing an example of error distribution weights in error diffusion processing according to the second embodiment of the present invention;

FIG. 12 is a view showing the pixel arrangement of a high resolution image according to the second embodiment of the present invention;

FIG. 13 is a view showing how error distribution is performed in error diffusion processing according to the second embodiment of the present invention;

FIG. 14 is a view showing the influence range of errors in error diffusing processing according to the second embodiment of the present invention;

FIG. 15 is a conceptual view showing an example of an image scanning sequence according to the second embodiment of the present invention;

FIG. 16 is a view showing an image input sequence in error diffusion processing according to the second embodiment of the present invention;

FIG. 17 is a view showing an image output sequence in error diffusion processing according to the second embodiment of the present invention;

FIG. 18 is a view showing an example of weights at the time of average density calculation according to the third embodiment of the present invention;

FIG. 19 is a view showing how error distribution is performed in an average density storage method according to the third embodiment of the present invention;

FIG. 20 is a view showing an influence range at the time of average density calculation according to the third embodiment of the present invention;

FIG. 21 is a view showing the influence range of errors in the average density storage method according to the third embodiment of the present invention;

FIG. 22 is a flowchart showing a processing procedure in an image forming apparatus according to the fourth embodiment of the present invention;

FIG. 23 is a view showing the necessary capacity of a line memory for alignment according to the fourth embodiment of the present invention; and

FIG. 24 is a flowchart concerning upsampling processing and halftone processing according to the first embodiment of the present invention.

### DESCRIPTION OF THE EMBODIMENTS

### First Embodiment

The first embodiment of the present invention will be described. The arrangement and outline of an apparatus to which the present invention can be applied will be described first.

<Arrangement of Image Forming Apparatus According to Present Invention>

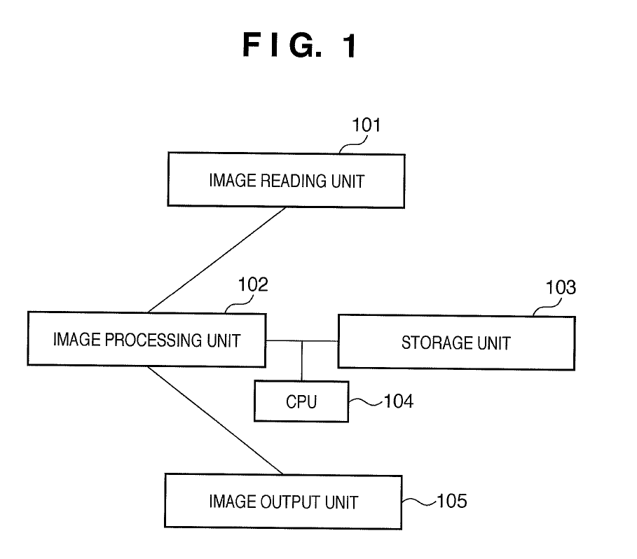

FIG. 1 is a block diagram showing an example of the arrangement of an image forming apparatus according to an embodiment of the present invention. As shown in FIG. 1, the image forming apparatus includes an image reading unit 101, an image processing unit 102, a storage unit 103, a CPU 104, and an image output unit 105. Note that the image forming apparatus can be connected to a server to manage image data, a personal computer (to be referred to as a PC hereinafter) to instruct the execution of printing, and the like via a network or the like.

The image reading unit 101 reads a document image and outputs image data. The image processing unit 102 converts print information containing image data input from the image reading unit 101 or an external device such as a PC into intermediate information (to be referred to as an “object” hereinafter), and stores the object in an object buffer in the storage unit 103. At this time, the image processing unit 102 performs image processing such as density correction. In addition, the image processing unit 102 generates bitmap data based on the buffered object and stores the data in a buffer in the storage unit 103. At this time, the image processing unit 102 performs density adjust processing, color conversion processing, printer gamma correction processing, halftone processing such as dither processing, and the like. Downsampling and upsampling processing which is a characteristic feature of the present invention is also performed in this block. This processing will be described in detail later.

The storage unit 103 includes a ROM, RAM, hard disk (to be referred to as an HD hereinafter). The ROM stores various control programs and image processing programs executed by the CPU 104. The RAM is used as a reference area and work area in which the CPU 104 stores data and various information. The RAM and the HD are also used as the above object buffer and the like. This apparatus accumulates image data in the RAM and the HD, sorts pages, and accumulates document data over a plurality of sorted pages, thereby printing out a plurality of copies. The image output unit 105 forms a color image on a printing medium such as a printing sheet and outputs it.

<Outline of Apparatus According to Embodiment>

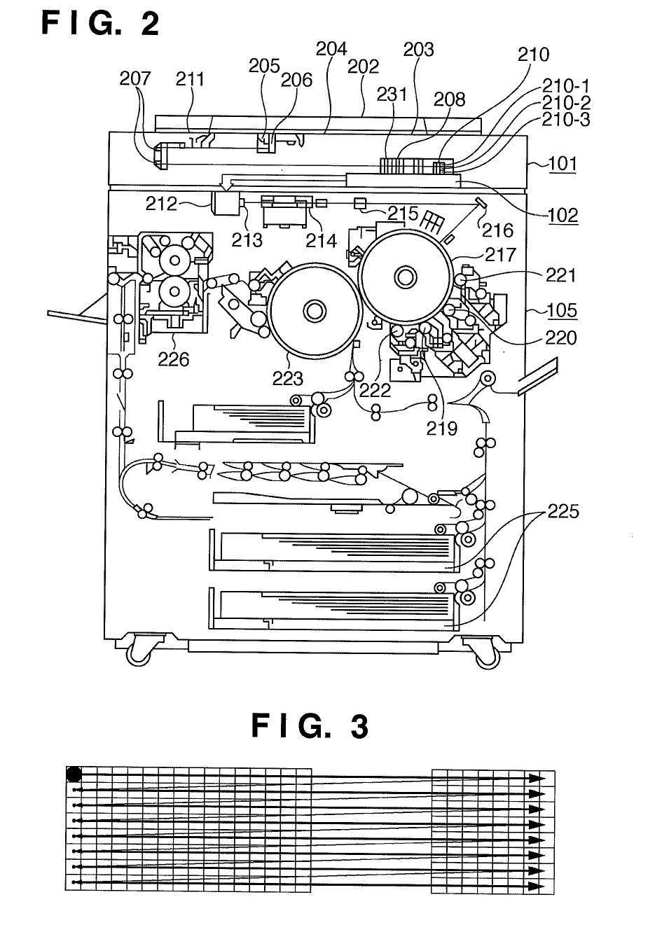

FIG. 2 is a schematic view of an example of the image forming apparatus according to the embodiment of the present invention. This apparatus performs print processing according to the following procedure.

In the image reading unit 101, a document 204 from which an image is to be read is placed between a document table glass 203 and a document press plate 202. The document 204 is irradiated with light from a lamp 205. Reflected light from the document 204 is guided to mirrors 206 and 207 and is formed into an image on a three-line sensor 210 by a lens 208. Note that the lens 208 is provided with an infrared cut filter 231. A motor (not shown) moves a mirror unit including the mirror 206 and the lamp 205 at a velocity V, and a mirror unit including the mirror 207 at a velocity V/2 in the direction indicated by the arrow. That is, the mirror units move in a vertical direction (sub scanning direction) relative to the electrical scanning direction (main scanning direction) of the three-line sensor 210 to scan the entire surface of the document 204.

The three-line sensor 210 including three-line CCDs color-separates input optical information and reads each of color components red R, green G, and blue B of full color information. Read color component signals R, G, and B are A/D-converted and are input as digital image data (to be referred to as image data or image signals hereinafter). The data are then sent to a signal processing unit 209. Note that the CCDs constituting the three-line sensor 210 have light-receiving elements corresponding to 5,000 pixels on each line, and can read an A3-size document, which is the maximum size that can be placed on the document table glass 203, in the widthwise direction of the document (297 mm) at a resolution of 600 dpi.

A standard white plate 211 corrects the data read by CCDs 210-1, 210-2, and 210-3 of the three-line sensor 210. The standard white plate 211 is white exhibiting an almost uniform reflection characteristic in visible light. The image processing unit 102 generates color component signals of magenta M, cyan C, yellow Y, and black K by electrically processing image signals input from the three-line sensor 210, and sends the generated color component signals of M, C, Y, and K to the image output unit 105.

The image output unit 105 sends the image signal of M, C, Y, or K sent from the image reading unit 101 to a laser driver 212. The laser driver 212 modulates and drives a semiconductor laser element 213 in accordance with the input image signal. A laser beam output from the semiconductor laser element 213 scans a photosensitive drum 217 through a polygon mirror 214, an f-θ lens 215, and a mirror 216 to form an electrostatic latent image on the photosensitive drum 217.

A developing device includes a magenta developing device 219, a cyan developing device 220, a yellow developing device 221, and a black developing device 222. The four developing devices alternately come into contact with the photosensitive drum 217 to develop the electrostatic latent image formed on the photosensitive drum 217 with a corresponding color toner, thereby forming a toner image. A printing sheet supplied from a printing sheet cassette 225 is wound around a transfer drum 223. The toner image on the photosensitive drum 217 is transferred onto the printing sheet.

The printing sheet onto which toner images of four colors M, C, Y, and K have been sequentially transferred in this manner passes through a fixing unit 226. As a consequence, the toner images are fixed on the sheet, and the printing sheet is then delivered outside the apparatus.

### <Overall Image Processing Procedure in Present Invention>

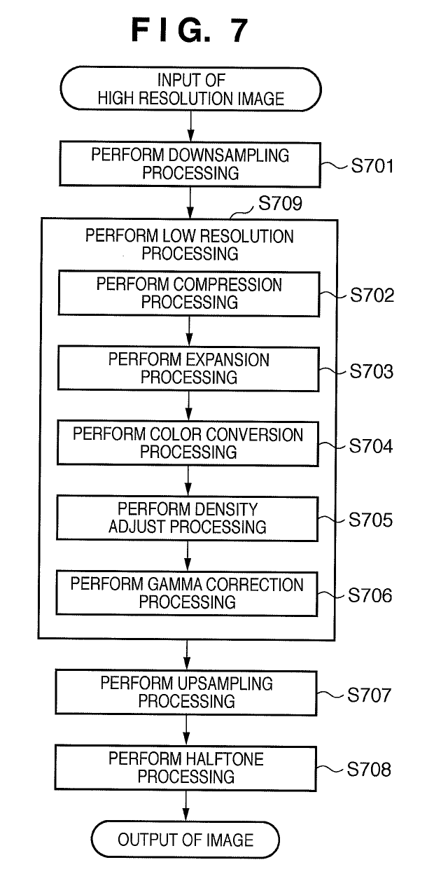

An overall image processing procedure in the image processing unit 102 described with reference to FIG. 1 will be described in detail next with reference to FIG. 7. First of all, in step S701, the image processing unit 102 divides the data input by the above CCDs as an input unit into image data blocks each having a predetermined size, and performs downsampling processing. In this case, downsampling processing is performed for the data to decrease the resolution by thinning out pixels, with the data being processed in 2 pixels (main scanning direction)×2 pixels (sub scanning direction). The image processing unit 102 implements this processing by obtaining and outputting one pixel with a representative pixel value from 2×2 pixels. Assume that an average value of 2×2 pixels is output as a representative pixel value for the time being.

Printer image processing generally requires low resolution processing for an image like that shown in steps S702 to S706. Note that in this embodiment, low resolution processing is processing for downsampled image data but does not indicate any processing contents. This image processing group is performed for a raster image. The number of pixels to be processed therefore directly influences a processing load. As compared with image processing for image data with vertical and horizontal sizes of 1,200 dpi and 600 dpi, the former processing requires a processing time four times that required by the latter processing, provided that the throughput remains unchanged, or requires a throughput four times that required by the latter processing, provided that the processing time remains unchanged.

If, however, the above downsampling processing (S701) is performed at the start of image processing, since the number of pixels input to subsequent image processing (S709) has decreased, the processing time and the necessary memory size decrease. In addition, it is possible to execute these image processes without specifically recognizing that the input image has been downsampled, and hence existing image processing can be applied. Finally, the image processing unit 102 performs upsampling processing (S707) and halftone processing (S708), thereby implementing a high resolution image output by low-cost image processing.

The flowchart of FIG. 7 will be described in detail below. In step S701, the image processing unit 102 performs image processing in step S709 for a sampled image. In step S709, first of all, the image processing unit 102 performs compression processing for the image data to store it in the memory or the hard disk (S702). In order to apply the subsequent processing to the image data, the image processing unit 102 reads out the compressed target data from the memory or the hard disk and reconstructs it to restore it to the raster image (S703). Thereafter, the image processing unit 102 performs color conversion processing for matching the image data with the output color space (S704). The image processing unit 102 then performs density adjustment (S705) and output gamma correction (S706).

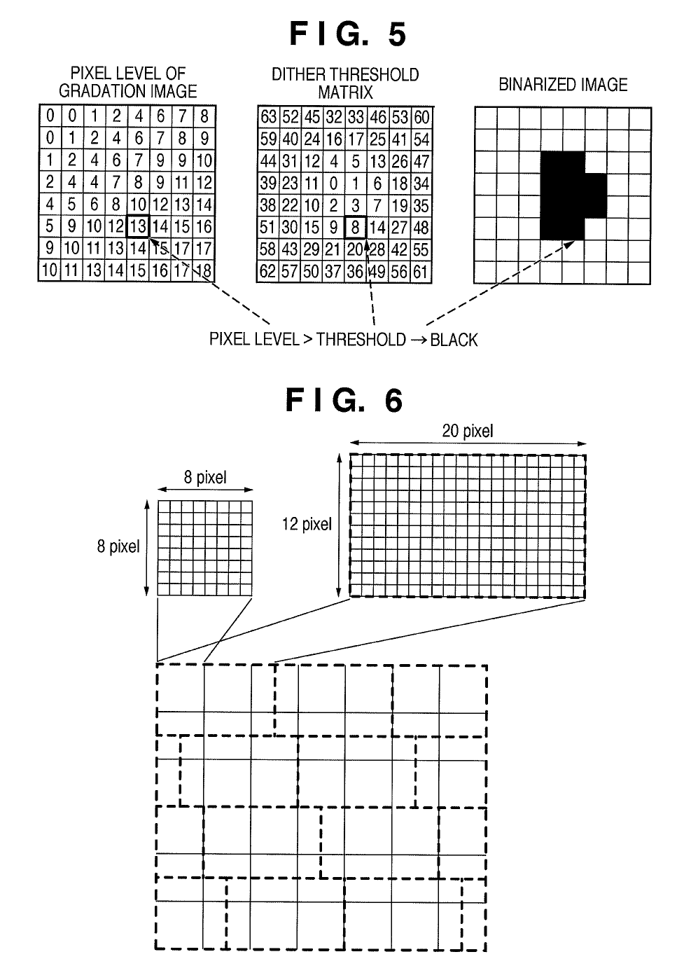

The image processing unit 102 then upsamples, for each block, the downsampled image for which image processing has been performed (S707). The image processing unit 102 receives one pixel of the low resolution image and outputs a block of 2×2 pixels of the image having the resolution before downsampling processing. The image processing unit 102 performs halftone processing for the reconstructed image (S708), and shifts to image output operation. This upsampling processing and halftone processing will be described in detail. Consider halftone processing using the dither method in this embodiment. The dither method is a technique of macroscopically storing density by converting image data having a multilevel gradation value per pixel into data having a smaller number of bits. As described above with reference to FIG. 5, the image processing unit 102 compares a dither threshold matrix with the pixel values of a target image. If a given pixel value is larger than the corresponding threshold, the image processing unit 102 outputs black. If a given pixel value is equal to or less than the threshold, the unit outputs white. In this manner, the image is binarized.

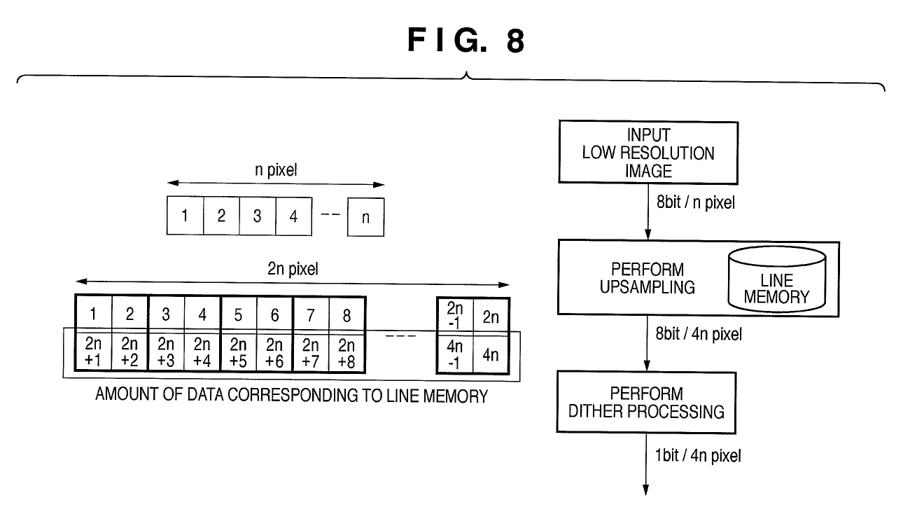

Upsampling processing will be described in detail. In the above upsampling processing, the image processing unit 102 receives one-pixel data and outputs 2×2 pixel data covering two lines. When an input is low resolution image data consisting of 1×n pixels as shown in FIG. 8, an output is 2×2n pixels. This makes it necessary to use a line memory corresponding to 1×n pixels as an output memory. This is a memory required to transfer pixel data having a width in the sub scanning direction to a subsequent processing module in sequence (i.e., in a raster scan order). The numbers in FIG. 8 indicate processing sequence numbers in processing performed in the raster scan order. When pixel “1” of low resolution image data is input, “1, 2, 2n+1, 2n+2” is output by upsampling processing. In this embodiment, for example, C, M, Y, and K components of data having undergone gamma correction processing each correspond to a memory amount required to store 10-bit image data corresponding to one line.

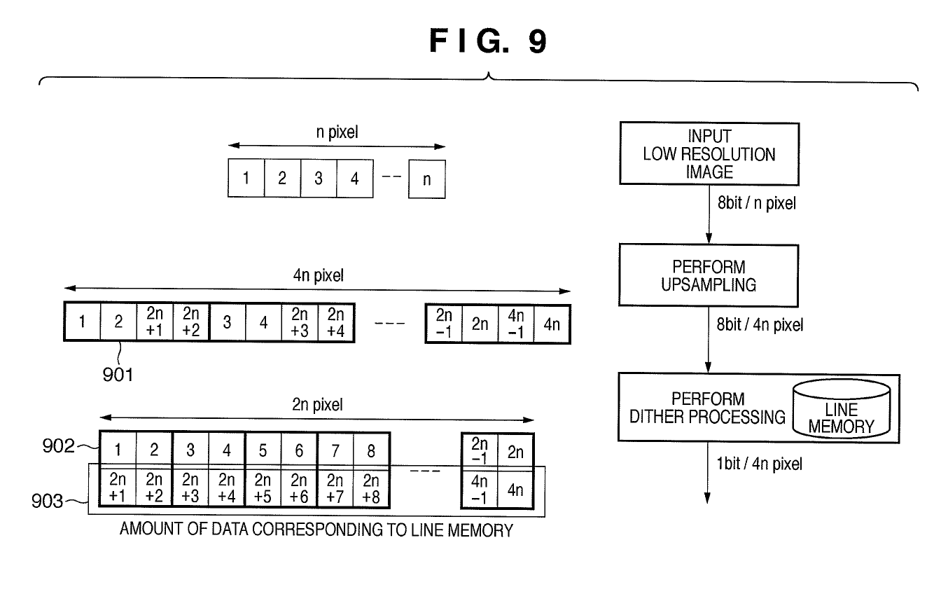

In order to reduce this memory amount, in upsampling processing in this embodiment, the image processing unit 102 transfers pixel data to the halftone processing unit in the order in which the data have been upsampled, without using any line memory for sending the data in sequence. As shown in FIG. 9, the image processing unit 102 upsamples one pixel to 2×2 pixels, that is, four pixels, handles them as a block of 4×1 pixels in a pseudo manner, instead of accumulating the two pixels belonging to the lower line in the memory, reduces the line memory, and performs dither processing for the pixels.

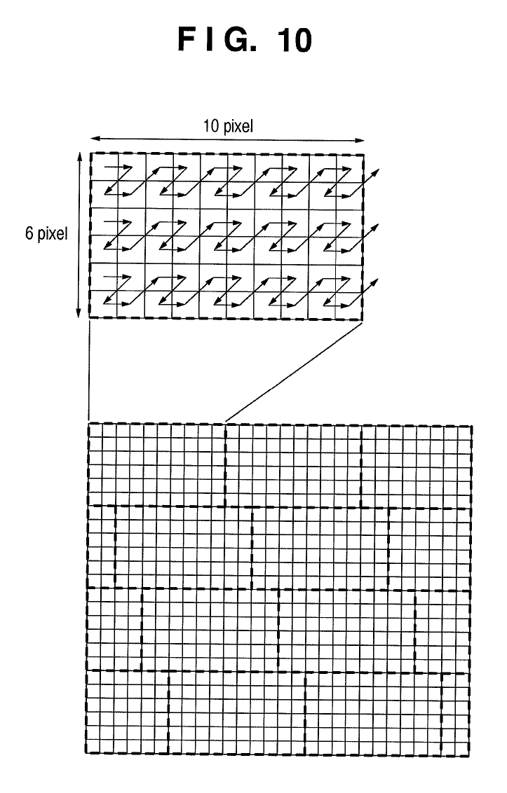

Obviously, however, when dither processing is directly performed for the image data, and the resultant image is printed, a data alignment mismatch occurs in the image. The dither processing unit therefore accesses a dither threshold matrix, for pixels which are normally arranged in a 2×2 matrix, so as to correspond to an arrangement in which the two pixels on the upper line and the two pixels on the lower line alternately appear on one line, thereby binarizing the image data. Referring to the above numbers, the pixel data assigned with the numbers 1 and 2 in image data 901 use two elements on an upper row of the dither threshold matrix as thresholds. In addition, the pixel data assigned with the numbers 2n+1 and 2n+2 in the image data 901 use two elements on the lower row of the dither threshold matrix as thresholds. FIG. 10 shows how the dither threshold matrix is accessed in this case.

As shown in FIG. 9, the dither processing unit receives pixel data in the order of 1, 2, 2n+1, 2n+2, 3, 4, . . . For this reason, the image processing unit 102 accesses the dither threshold matrix used in this case in a zigzag manner so as to set thresholds to be applied in a normal coordinate system.

FIG. 10 shows how a dither threshold matrix accesses the pixels output in the sequence shown in FIG. 9. Referring to FIG. 10, the dither period corresponds to a unit of 10×6 pixels, and the sequence of access to the dither threshold matrix is expressed by the letter “Z”.

After binarization is performed in this access sequence, the data are sorted. More specifically, the image processing unit 102 sorts the data of a 4×1 pixel block after binarization into the data of a 2×2 pixel block. As described above, the upsampling unit outputs high resolution pixel data consisting of four pixels from low resolution pixel data consisting of one pixel. The data sequence in this case is represented by 1, 2, 2n+1, and 2n+2. Therefore, in accordance with this sequence, the image processing unit 102 sorts the pixel data by arranging 2n+1 and 2n+2 on the line below 1 and 2.

A line memory 903 of the dither processing unit stores the sorted data. The line memory 903 can store all data 902 after sorting or store only the data of the second line of the data 902 while outputting the data of the first line of the data 902 to the print processing unit.

After dither processing, the number of bits per pixel has decreased. This allows the line memory 903 which stores the sorted data to have a smaller capacity. If, for example, multilevel data is 10-bit data, the capacity of the line memory secured for the binarized data can be reduced to 1/10.

It is possible to obtain a final printout by sorting data in this manner, transferring the image data to the print processing unit, causing the laser driver of the print processing unit to receive the data, and performing laser scanning.

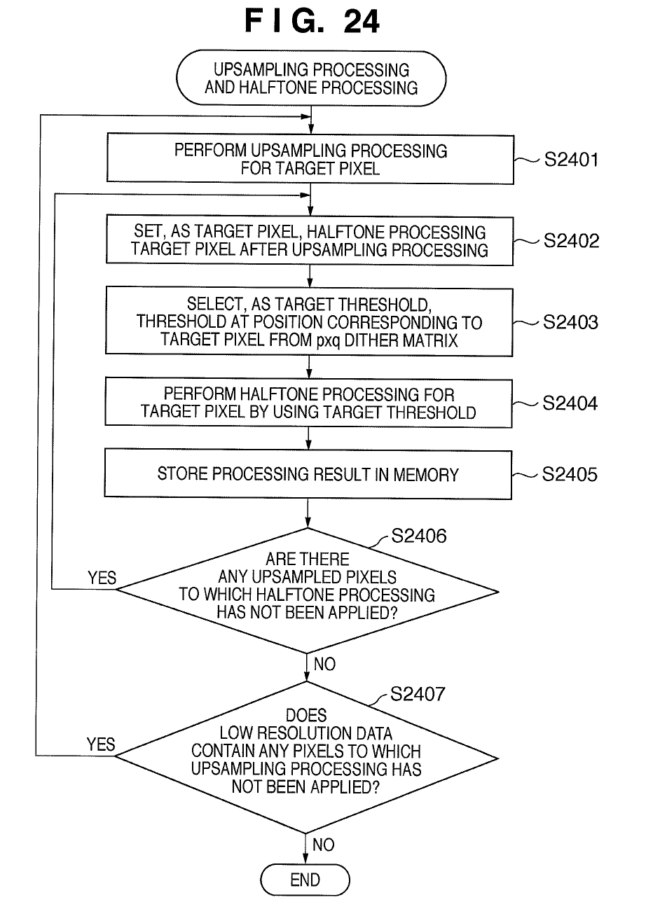

FIG. 24 summarizes upsampling processing and halftone processing as a flowchart. Upsampling processing is performed for each pixel of low resolution pixel data (S2401). A pixel which is contained in the image data after upsampling processing and is to be subjected to halftone processing is set as a target pixel (S2402). A threshold corresponding to the target pixel is selected as a target threshold from a dither matrix having a size of p×q (a size of 12×20 in the case of FIG. 6) (S2403). Halftone processing is performed for the target pixel by using the target threshold (S2404). The halftone processing result is stored in the memory (S2405). If the pixel data having undergone upsampling processing includes any pixels for which halftone processing has not been performed, the process returns to step S2402 to repeat the above processing (S2406). If this pixel data includes no such data, the process advances to step S2407. If there is image data having undergone low resolution processing which is to be upsampled, the process returns to step S2401 to repeat the above processing (S2407). If there is no such data, the processing is terminated.

In this embodiment, when image data is to be converted into high resolution image data, the number of pixels to be processed is decreased, that is, low resolution processing is performed, at the time of image processing such as color conversion processing. Even if, therefore, a high resolution image is input, it is possible to suppress increases in processing time and processing resources. In this case, accessing a dither threshold matrix in consideration of the coordinates after sorting can prevent mismatches at block joint boundaries. In addition, sorting data after the data amount is reduced can reduce a line memory. This makes it possible to output an image at low cost.

Although the above description concerns 2×2 pixel block division alone, the present invention is not limited to this. Obviously, with an increase in block size, the size of the line memory increases. Although the above description is based on the assumption that the number of bits of an output obtained by dither processing is one, the present invention is not limited to this as long as the number of bits of an output is smaller than that of a multilevel input. Furthermore, upsampling processing indicates processing in general which includes general enlargement processing and in which the number of pixels processed increases in the sub scanning direction.

As described above, this embodiment is configured to immediately quantize (binarize in this embodiment) upsampled multilevel image data by performing dither processing without storing it in the line buffer and store the quantized image data in the line memory as needed. This eliminates the necessity of a line memory having a large capacity required for upsampling.

### Second Embodiment

Image processing according to the second embodiment of the present invention will be described below. This embodiment will exemplify a case in which error diffusion processing is performed when halftone processing is performed. As a method of converting an image made of multilevel pixel data into binary image data while macroscopically storing tone, an error diffusion method is known in addition to the above method using the dither threshold matrix.

This embodiment is the same as the above embodiment in the steps in FIG. 7 in which after downsampled low resolution image is upsampled by various types of image processing, halftone processing is performed. Therefore, this procedure is also applied to the second embodiment. The second embodiment differs from the first embodiment in that binarization using the error diffusion method is performed instead of binarization using a dither threshold matrix in halftone processing. In this case, it is necessary to handle error data and data for sorting in addition to image data.

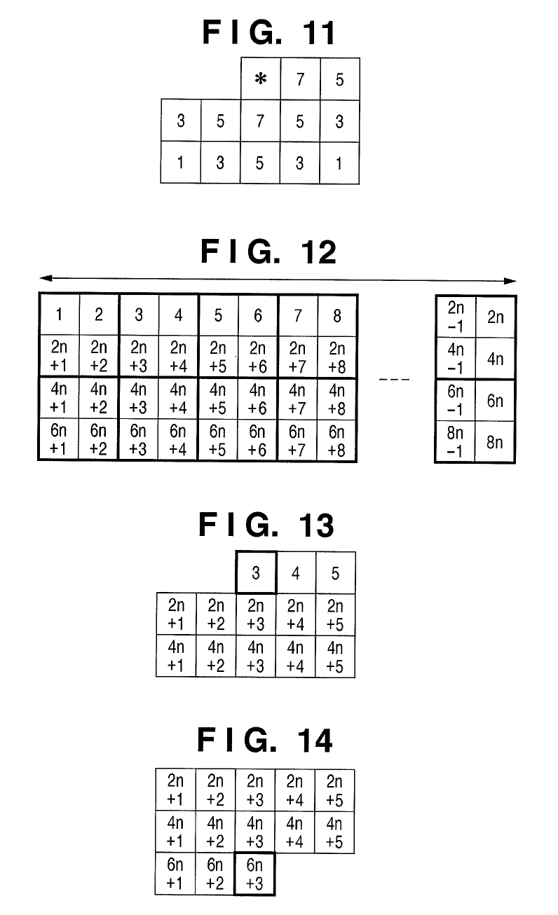

A typical technique of the error diffusion method will be exemplified with reference to FIGS. 11 and 12. In this case, as described in Japanese Patent Laid-Open No. 2006-345385 and the like, a known error diffusion method is used as an example. As shown in FIG. 11, an error diffusion mask for error diffusion used in this description takes a typical shape of a 5×3 matrix designed to distribute errors to the pixels of a portion, of 5×5 pixels centered around a target pixel (*), for which halftone processing has not been performed. The numbers in this mask indicate diffusion weights, which increase with a decrease in distance to the target pixel and decrease with an increase in distance from the target pixel. The weights in FIG. 11 represent ratios. In order to weight an error, it is necessary to divide the corresponding number by the total sum of errors in the mask. For example, for the pixel with the weight “7”, 7/48 of the quantization error at the target pixel is diffused. In the case of this mask, errors are transmitted to a total of 12 pixels, that is, two pixels located forward in the main scanning direction, two pixels located backward in the main scanning direction (processed pixels are not included as pixels to be processed), and two pixels located forward in the sub scanning direction relative to the target pixel, thereby influencing the processing results on the pixels located at the corresponding positions.

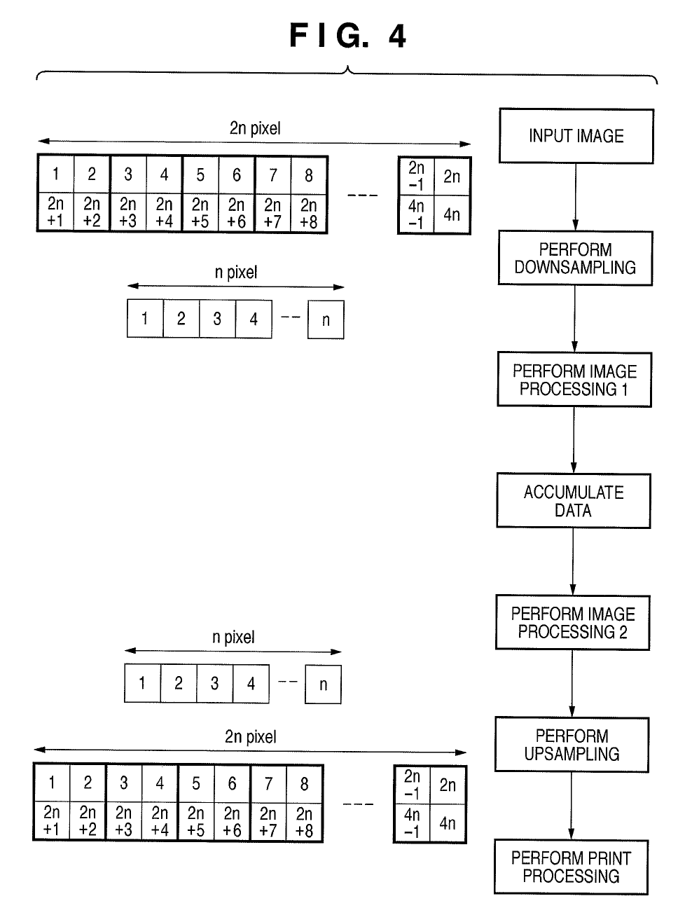

Like FIG. 4, FIG. 12 shows a scan sequence in the main scanning direction in a case in which the width of an image in the main scanning direction after upsampling is 2n pixels, and the upper left pixel of the image is set as the first pixel. Referring to FIG. 12, if, for example, the third pixel is a target pixel, density errors at the time of binarization are diffused in the range of the 4th, 5th, (2n+1)th to (2n+5)th, and (4n+1)th to (4n+5)th pixels (FIG. 13). As described above, if the upsampling processing unit sends image data in the order in which they have been upsampled, a target pixel is binarized before an error is completely transmitted to the target pixel. If binarization is performed in this manner, it is impossible to macroscopically store the density. As a result, an unnatural edge is formed at the boundary between blocks each consisting of 2×2 pixels. This edge may be visually recognized.

It is therefore necessary to hold the data of a target pixel to be binarized until it completely receives a diffused error. Consider next the binarization of a target pixel located at the position of 6n+3 in FIG. 12. The number of pixels which can transmit errors to the target pixel is 12, namely 2n+1 to 2n+5, 4n+1 to 4n+5, 6n+1, and 6n+2. It is necessary to complete binarization processing of these pixels before the binarization of pixel 6n+3 (FIG. 14).

However, the image data from the upsampling processing unit flow in the order of 1, 2, 2n+1, 2n+2, 3, 4, 2n+3, . . . It is therefore necessary to hold the data on the two lines above the target pixel to perform binarization processing in the raster order. More specifically, consider binarization processing of pixels 2n+1 and 2n+2. In this case, even when pixels 2n+1 and 2n+2 are input, pixels 3 and 4 have not been binarized, and errors have not been diffused. For this reason, the two pixels (pixels 2n+1 and 2n+2) are accumulated in the memory and set in a standby state until pixels 3 and 4 are binarized. It is therefore necessary to hold binarization processing. When the binarization of pixels 3 and 4 is complete and errors are determined, pixels 2n+1 and 2n+2 accumulated in the memory can be binarized. Likewise, since pixels 2n+3 and 2n+4 need to be set in a standby state until the end of binarization of pixels 5 and 6, pixels 2n+3 and 2n+4 are overwritten and accumulated in the memory in which pixels 2n+1 and 2n+2 have been stored and set in a standby state until the end of binarization of pixels 5 and 6. Performing error diffusion and binarization in this sequence can obtain results equivalent to those obtained by a normal scan like 1, 2, 3, 4, . . . This prevents the appearance of inter-block boundaries. Binarization errors are distributed according to an error diffusion mask. The distributed errors are accumulated and stored in the line memory and diffused to corresponding upsampled pixels.

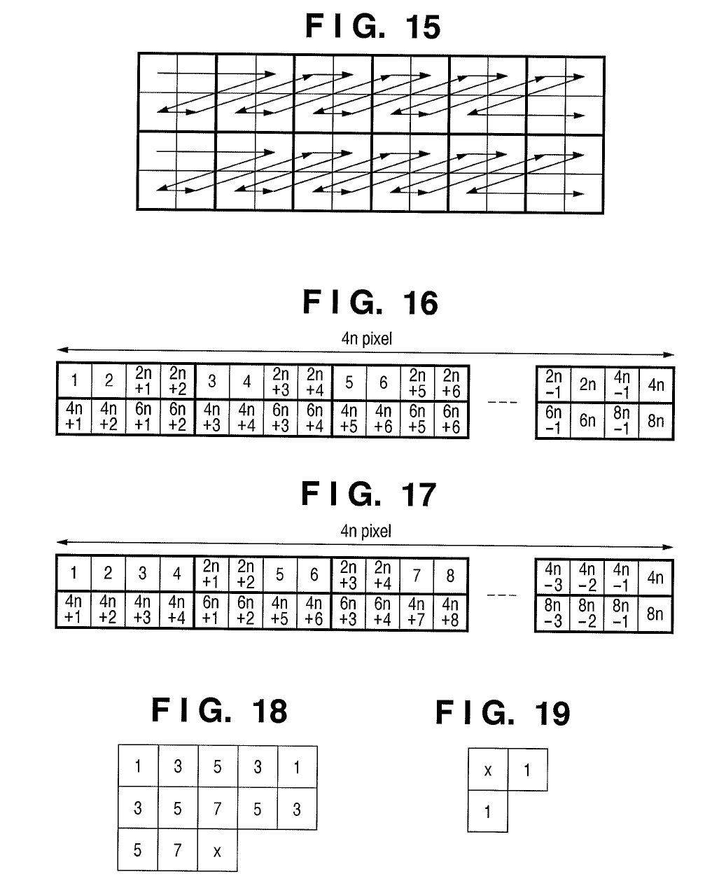

FIG. 15 shows a processing sequence for an image for error diffusion in this embodiment. Such zigzag scanning can perform error diffusion without requiring any line memory. That is, FIG. 17 shows a pixel output sequence corresponding to the pixel input sequence shown in FIG. 16. In this embodiment, an input is swapped by two pixels. It is possible to obtain a final output by sorting the data binarized in this manner after the above processing while additionally providing a line memory, as described in the first embodiment.

As a consequence, when the error diffusion method and upsampling are simultaneously performed, the required memory size, excluding a portion corresponding to image data, becomes the following, provided that the number of pixels per line is represented by m, and error data consists of eight bits. That is, this size is defined by a total of 17m bits, including 8×2m bits for an error memory corresponding to the two lines immediately below the target pixel, which correspond to the influence range of the target pixel, and m bits for a binarization memory corresponding to the one line immediately below the target pixel, which is required for sorting. At this time, it is necessary to hold the data of two pixels adjacent to the target pixel in the main scanning direction. Since this value can be neglected if m is very large, the value is neglected in this case. As described above, it is possible to minimize increases in line memory and error memory required for the processing and output a final output image while maintaining the image quality.

### Third Embodiment

Image processing according to the third embodiment of the present invention will be described below. This embodiment will exemplify a case in which when halftone processing is performed, an average density storage method is performed, that is, each pixel is binarized while the average density of neighboring pixels is held. This embodiment is the same as the above embodiment in the steps in FIG. 7 in which after downsampled low resolution image is upsampled by various types of image processing, halftone processing is performed. Therefore, this procedure is also applied to the third embodiment. This embodiment differs from the first and second embodiments in that binarization is performed by using the average density storage method in halftone processing. In this case, it is necessary to handle error data and data for the calculation of an average density in addition to image data.

A typical technique of the average density storage method will be exemplified with reference to FIGS. 18 to 21. According to the average density storage method used in this case, a mask like that shown in FIG. 18 is applied to pixels located near a target pixel and binarized before the binarization of the target pixel. Each threshold provided by the mask is compared with the pixel value of the target pixel to perform binarization. The error generated at this time is distributed to one adjacent pixel (FIG. 19).

The average density storage method is advantageous over the above error diffusion method in that error diffusion processing requires an error memory corresponding to two multilevel lines, whereas the average density storage method requires only two binary lines+one multilevel line. This is because data required for processing the target pixel are those which have already been accumulated and binarized. In the error diffusion method, error data to be diffused is diffused to pixels two lines ahead, the data must be accumulated as multilevel data corresponding to two lines. In contrast to this, in the average density storage method, since accumulated data are binarized data for the calculation of thresholds, the memory capacity required for the same two lines can be smaller. The average density storage method is also advantageous in that it need not diffuse error data obtained by binarization to distant pixels and only needs to diffuse them to two adjacent pixels at most because thresholds are dynamically obtained for the respective pixels in the distribution of the error data.

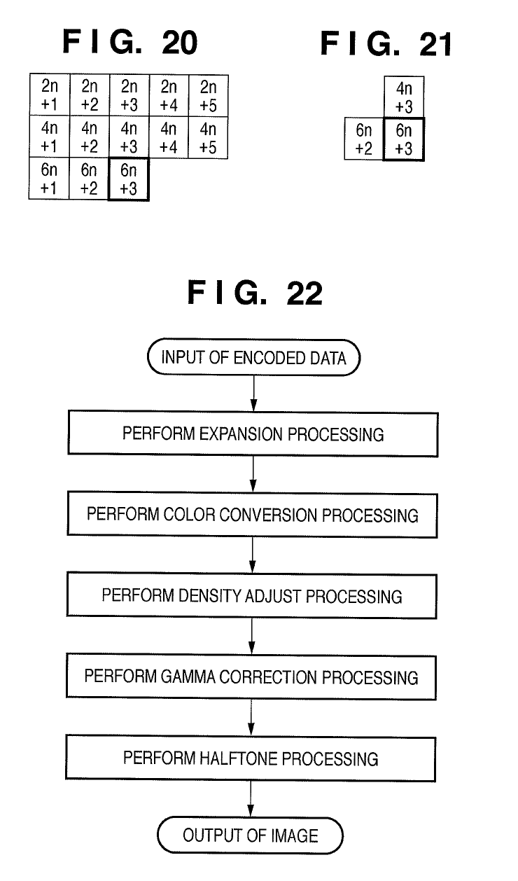

Consider pixel 6n+3 in FIG. 12. When this pixel is to be binarized, the position where a mask is applied corresponds to 12 pixels, namely pixels 2n+1 to 2n+5, 4n+1 to 4n+5, 6n+1, and 6n+2 (FIG. 20). In addition, pixels 4n+3 and 6n+2 are pixels for which error distribution needs to have been completed by binarization (FIG. 21). That is, when pixel 6n+3 is to be binarized, binarization processing of the above pixels needs to have been completed. However, image data from the upsampling processing unit flow, from the start, in the order of pixels 1, 2, 2n+1, 2n+2, 3, 4, 2n+3, . . . In order to perform processing in this order, therefore, it is necessary to hold data. More specifically, even when pixels 2n+1 and 2n+2 are input, since processing cannot be started until pixels 3 and 4 are binarized, the pixels to be processed are set in a standby state by using a memory. The processing can be performed when the processing of pixels 3 and 4 is complete. Consider a processing sequence as in the second embodiment. The procedure in this processing is the same as that shown in FIG. 15 as in error diffusion processing.

When the average density storage method is to be used, the memory is made to store binarized pixel data corresponding to two lines. For this reason, using the error diffusion method described in the second embodiment will eliminate the necessity of a memory area which is additionally required for sorting, and can output pixels in sequence.

As a consequence, when the average density storage method and upsampling are simultaneously performed, the required memory size, excluding a portion corresponding to image data, becomes the following, provided that the number of pixels per line is represented by m, and error data consists of eight bits. That is, this size is defined by a total of 10m bits, including 8m bits for an error memory corresponding to one line immediately below the target pixel, which correspond to the influence range of the target pixel, and 2m bits for a line memory corresponding to two lines immediately above the target pixel, which correspond to a range for average density calculation.

As described above, it is possible to minimize increases in line memory and error memory required for the processing and output a final output image while holding the image quality.

### Fourth Embodiment

Image processing according to the fourth embodiment of the present invention will be described below. This embodiment will exemplify the expansion of a compressed image which can be divided into blocks instead of upsampling. Image compression and expansion typified by JPEG are often performed in blocks each having a width in the sub scanning direction, and 8×8 pixel blocks are often used in JPEG. When compressed image data is expanded and decoded, it is necessary to perform sort processing in the sub scanning direction as in the case with upsampling.

<Image Processing Scheme for Compressed Image on Block Basis>

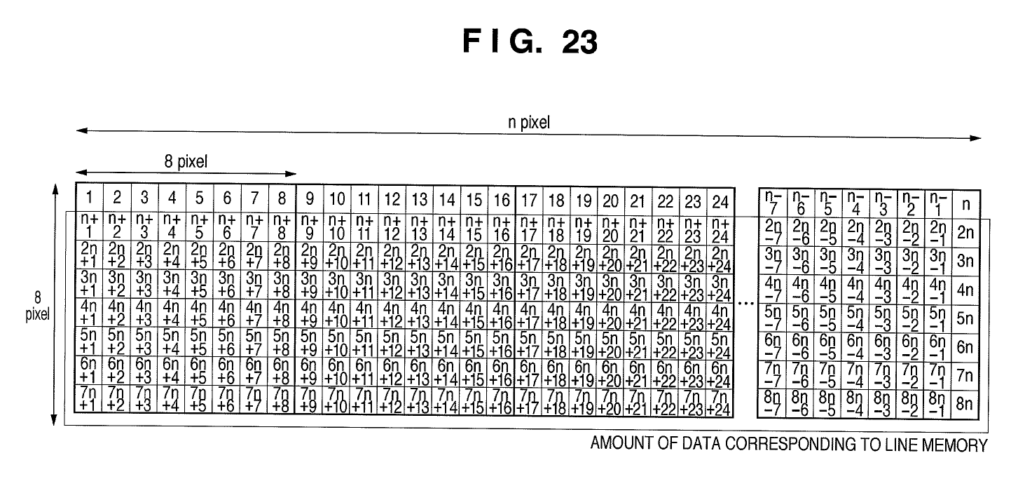

FIG. 22 shows an overall processing procedure associated with an expansion technique for a compressed image. As in the embodiment described with reference to FIG. 7, this scheme executes image processing such as color conversion processing, density adjust processing, and gamma correction processing for input and expanded image data for each block, and then performs halftone processing to thin out the number of pixels of the image. Thereafter, the print processing unit transfers the data. For this reason, in general, as shown in FIG. 23, a 7-line memory is used for decoded image data to align the data. Thereafter, image processing is performed for the data. The resultant data are output to the printer unit in sequence.

Referring to FIG. 23, there are n pixels (n is a multiple of eight) in the main scanning direction, and the numbers in the respective pixels indicate the sequence of decoded image data. In JPEG decoding processing, when the first code (MCU) data is input, the corresponding output is an 8×8 pixel block. Referring to FIG. 23, when the first one code is input, the data of 64 pixels, namely pixels 1 to 8, n+1 to n+8, . . . , 7n+1 to 7n+8, are output. In order to output data, decoded in this order, orderly in the main scanning sequence, that is, 1 to n, a 7-line memory like that shown in FIG. 23 is required. Obviously, however, as described in the above embodiments, if this scheme includes the processing of reducing the number of bits of a halftone image, aligning the data after a reduction in the number of bits can greatly reduce the memory capacity required. In this case as well, it is possible to orderly perform the processing by using the above dither threshold matrix access method, error diffusion method, and average density storage method.

This makes it possible to obtain an image output while maintaining the image quality without being conscious of any block boundaries of the output image.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2009-010406, filed Jan. 20, 2009, which is hereby incorporated by reference herein in its entirety.

What is claimed is:

1. An image forming apparatus which performs print processing of image data, comprising:
an expansion unit which performs downsampling processing for input image data, and then restores a target pixel of the image data, for which image processing has been performed, to the number of pixels at the time of input;
a conversion unit which converts each pixel corresponding to the target pixel, restored to the number of pixels at the time of input by said expansion unit, into a pixel for printing; and
a sort unit which reads each pixel corresponding to the target pixel converted by said conversion unit, reads the pixels in a raster order, and sorts the pixels.

2. The apparatus according to claim 1, further comprising:
an input unit which inputs high resolution image data from outside;
a division unit which divides the image data input by said input unit into image data each having a predetermined size;
a reduction unit which reduces the number of pixels with respect to the target pixel of image data divided by said division unit; and
a holding unit which holds image data processed in sequence by said reduction unit,
wherein said expansion unit sets image data held by said holding unit as a processing target.

3. The apparatus according to claim 1, further comprising:
an input unit which inputs divisible compressed image data;
an expansion unit which expands the compressed image data input by said input unit;
a reduction unit which reduces the number of pixels of the image data expanded by said expansion unit; and
a holding unit which holds the image data processing in sequence by said reduction unit,
wherein said expansion unit sets image data held by said holding unit as a processing target.

4. The apparatus according to claim 1, wherein said conversion unit performs dither processing by using a dither threshold matrix.

5. The apparatus according to claim 1, wherein said conversion unit processes pixel data by using an error diffusion method in an order in which error distribution has been completed for the pixel data.

6. The apparatus according to claim 1, wherein said conversion unit processes pixel data by using an average density storage method in an order in which error distribution has been completed for the pixel data and thresholds are configured to be calculated.

7. An image forming apparatus comprising:
a conversion unit which inputs image data and upsamples the image data to image data having a higher resolution;
a dither processing unit which reads each pixel of the image data converted by said conversion unit in a raster scan order, and performs dither processing by using a dither threshold corresponding to said each pixel in the raster scan order; and
a sort unit which sorts said each pixel for which dither processing is performed by said dither processing unit.

8. A control method for an image forming apparatus which performs print processing of image data, comprising:
the expansion step of causing an expansion unit of the image forming apparatus to perform downsampling processing for input image data and then restore a target pixel of the image data, for which image processing has been performed, to the number of pixels at the time of input;
the conversion step of causing a conversion unit of the image forming apparatus to convert each pixel corresponding to the target pixel, restored to the number of pixels at the time of input in the expansion step, into a pixel for printing; and
the sort step of causing a sort unit of the image forming apparatus to read each pixel corresponding to the target pixel converted in the conversion step, read the pixels in a raster order, and sort the pixels.

9. A control method for an image forming apparatus which performs print processing of image data, comprising:
the conversion step of causing a conversion unit of the image forming apparatus to input image data and upsample the image data to image data having a higher resolution;
the dither processing step of causing a dither processing unit of the image forming apparatus to read each pixel of the image data converted in the conversion step in a raster scan order and perform dither processing by using a dither threshold corresponding to said each pixel in the raster scan order; and
the sort step of causing a sort unit of the image forming apparatus to sort said each pixel for which dither processing is performed in the dither processing step.

10. A control program storable in a storage medium readable by a computer, the control problem being adapted to make the computer execute an image processing method, the image processing method executed by the computer comprising the steps of:
an expansion step of performing downsampling processing for input image data, and then restores a target pixel of the image data, for which image processing has been performed, to the number of pixels at the time of input;
a conversion step of converting each pixel corresponding to the target pixel, restored to the number of pixels at the time of input by the expansion step, into a pixel for printing; and
a sort step of reading each pixel corresponding to the target pixel converted by the conversion step, reads the pixels in a raster order, and sorts the pixels.

11. A control program storable in a storage medium readable by a computer, the control problem being adapted to make the computer execute an image processing method, the image processing method executed by the computer comprising the steps of:
a conversion step of inputting image data and upsamples the image data to image data having a higher resolution;
a dither processing step of reading each pixel of the image data converted by the conversion step in a raster scan order, and performs dither processing by using a dither threshold corresponding to said each pixel in the raster scan order; and
a sort step of sorting said each pixel for which dither processing is performed by the dither processing step.
